(19) United States
(12) Patent Application Publication
(10) Pub. No.: US 2026/0338086 A1
(43) Pub. Date: Oct. 29, 2026

(54) LUBRICATION CONTROL SYSTEM FOR A TURBINE ENGINE GEAR ASSEMBLY

(71) Applicants: General Electric Company, Evendale, OH (US); GE Avio S.r.l., Rivalta di Torino (IT)

(72) Inventors: Brandon W. Miller, Middletown, OH (US); Andrew Hudecki, Milford, OH (US); Federico Leonardi, Vinovo (IT); Miriam Manzoni, Rivalta di Torino (IT)

(21) Appl. No.: 19/188,773

(22) Filed: Apr. 24, 2025

(51) Int. Cl. F01D 25/18; F16H 57/04

(52) U.S. Cl. CPC F01D 25/18; F16H 57/0435; F16H 57/0456; F05D 2220/32; F05D 2220/40; F05D 2260/60; F05D 2260/98; F05D 2270/301; F16H 57/0482

(57) ABSTRACT

A lubrication control system for a gear assembly of a gearbox in a turbine engine, the lubrication control system including a lubricant supply having a lubricant supply line to feed lubricant to the gearbox, a lubricant injector providing the lubricant to the gear assembly, and a lubricant control module configured to slidably cover the first orifice type or the second orifice type to change the flow of lubricant. The lubricant injector includes a plurality of orifices, including a first orifice type providing a first output and a second orifice type providing a second output greater than the first output. The plurality of orifices receives lubricant from a same feed line, the lubricant exits through the plurality of orifices as a flow of lubricant, and the plurality of orifices directs the lubricant to the gear assembly.

### TECHNICAL FIELD

The present disclosure relates generally to lubrication systems, for example, for gear assemblies in turbine engines.

### BACKGROUND

Turbine engines generally include a fan section and a turbo-engine arranged in flow communication with one another. A gear assembly transfers torque and power from one rotating component to another rotating component (e.g., from the core section to the fan, or to provide power to auxiliary components of the turbine engine or portions of an aircraft). A lubrication system provides lubricant to one or more components of the gear assembly.

### BRIEF DESCRIPTION OF THE DRAWINGS

Features and advantages will be apparent from the following, more particular, description of various exemplary embodiments, as illustrated in the accompanying drawings, wherein like reference numbers generally indicate identical, functionally similar, structurally similar, or both functionally similar and structurally similar elements.

FIG. 1 is a schematic, cross-sectional diagram of a turbine engine, taken along a longitudinal centerline axis of the turbine engine, according to the present disclosure.

FIG. 2 is a schematic, cross-sectional view of a gearbox assembly taken along line 2-2 in FIG. 1 and a lubrication system, according to the present disclosure.

FIG. 3A is a schematic, cross-sectional view of a face of a lubricant injector, according to the present disclosure.

FIG. 3B is a schematic, cross-sectional view of the face of the lubricant injector in FIG. 3A after a lubricant control module has moved in a first direction, according to the present disclosure.

FIG. 3C is a schematic, cross-sectional view of the face of the lubricant injector in FIG. 3A after the lubricant control module has moved in a second direction, according to the present disclosure.

FIG. 4A is a schematic, cross-sectional view of a face of a lubricant injector, according to the present disclosure.

FIG. 4B is a schematic, cross-sectional view of the face of the lubricant injector in FIG. 4A after the lubricant control module has moved in a first direction, according to the present disclosure.

FIG. 4C is a schematic, cross-sectional view of the face of the lubricant injector in FIG. 4A after the lubricant control module has moved in a second direction, according to the present disclosure.

### DETAILED DESCRIPTION

Features, advantages, and embodiments of the present disclosure are set forth or apparent from a consideration of the following detailed description, drawings, and claims. Moreover, the following detailed description is exemplary and intended to provide further explanation without limiting the scope of the disclosure as claimed.

Various embodiments of the present disclosure are discussed in detail below. While specific embodiments are discussed, this is done for illustration purposes only. A person skilled in the relevant art will recognize that other components and configurations may be used without departing from the present disclosure.

As used herein, the terms “first,” “second,” etc., may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

As used herein, the term “axial” refers to directions and orientations that extend substantially parallel to a longitudinal centerline of the turbine engine. Moreover, the terms “radial” and “radially” refer to directions and orientations that extend substantially perpendicular to the longitudinal centerline of the turbine engine. In addition, as used herein, the term “circumferentially” refers to directions and orientations that extend arcuately about the longitudinal centerline of the turbine engine.

As used herein, the terms “low,” “mid” (or “mid-level”), and “high,” or their respective comparative degrees (e.g., “lower” and “higher”, where applicable), when used with compressor, combustor, turbine, shaft, fan, or turbine engine components, each refers to relative pressures, relative speeds, relative temperatures, or relative power outputs within an engine unless otherwise specified. For example, a “low-power” setting defines the engine or the combustor configured to operate at a power output lower than that of a “high-power” setting of the engine or the combustor, and a “mid-level-power” setting defines the engine or the combustor configured to operate at a power output higher than that of a “low-power” setting and lower than that of a “high-power” setting. The terms “low,” “mid” (or “mid-level”) or “high” may additionally, or alternatively, be understood as relative to minimum allowable speeds, pressures, or temperatures, or maximum allowable speeds, pressures, or temperatures relative to normal, desired, steady state, etc., operation of the engine. A mission cycle for a turbine engine includes, for example, a low-power operation, a mid-level-power operation, and a high-power operation. Low-power operation includes, for example, engine start, idle, taxiing, and approach. Mid-level-power operation includes, for example, cruise. High-power operation includes, for example, takeoff and climb.

The various power levels of the turbine engine are defined as a percentage of a sea level static (SLS) maximum engine rated thrust. Low-power operation includes, for example, less than thirty percent (30%) of the SLS maximum engine rated thrust of the turbine engine. Mid-level-power operation includes, for example, thirty percent (30%) to eighty-five percent (85%) of the SLS maximum engine rated thrust of the turbine engine. High-power operation includes, for example, greater than eighty-five percent (85%) of the SLS maximum engine rated thrust of the turbine engine. The values of the thrust for each of the low-power operation, the mid-level-power operation, and the high-power operation of the turbine engine are exemplary only, and other values of the thrust can be used to define the low-power operation, the mid-level-power operation, and the high-power operation.

As used herein, “cruise,” “cruise conditions,” or “cruise altitude” is generally an altitude at which an aircraft levels after climb and prior to descending to an approach flight phase. In various examples, the engine is applied to a vehicle with a cruise altitude up to approximately 65,000 ft. In certain examples, cruise altitude is between approximately 28,000 ft. and approximately 45,000 ft. In still certain examples, cruise altitude is expressed in flight levels (FL) based on standard air pressure at sea level, in which a cruise flight condition is between FL280 and FL650. In another example, cruise flight condition is between FL280 and FL450. In still certain examples, cruise altitude is defined based at least on barometric pressure, in which cruise altitude is between approximately 4.85 psia and approximately 0.82 psia based on a sea-level pressure of approximately 14.70 psia and sea-level temperature at approximately 59 degrees Fahrenheit. In another example, cruise altitude is between approximately 4.85 psia and approximately 2.14 psia. It should be appreciated that in certain examples, the ranges of cruise altitude defined by pressure may be adjusted based on a different reference sea-level pressure, sea-level temperature, or sea-level pressure and sea-level temperature.

The terms “coupled,” “fixed,” “attached,” “connected,” and the like, refer to both direct coupling, fixing, attaching, or connecting, as well as indirect coupling, fixing, attaching, or connecting through one or more intermediate components or features, unless otherwise specified herein.

The singular forms “a,” “an,” and “the” include plural references unless the context clearly dictates otherwise.

As used herein, a “turbo-engine” includes a compressor section, a combustion section, and a turbine section.

Approximating language, as used herein throughout the specification and claims, is applied to modify any quantitative representation that could permissibly vary without resulting in a change in the basic function to which it is related. Accordingly, a value modified by a term or terms, such as “approximately,” “generally,” and “substantially” is not to be limited to the precise value specified. In at least some instances, the approximating language may correspond to the precision of an instrument for measuring the value, or the precision of the methods or the machines for constructing the components or the systems or manufacturing the components or the systems. For example, the approximating language may refer to being within a one, two, four, ten, fifteen, or twenty percent margin in either individual values, range(s) of values, or endpoints defining range(s) of values.

H ere and throughout the specification and claims, range limitations are combined, and interchanged. Such ranges are identified and include all the sub-ranges contained therein unless context or language indicates otherwise. For example, all ranges disclosed herein are inclusive of the endpoints, and the endpoints are independently combinable with each other.

As used herein, the term “mesh” or “meshing” refers to a location between two gears at which gear teeth of the two gears become intertwined, or otherwise become mated.

As used herein, the term “in-mesh” or “in-mesh side” refers to a location of a meshing between two gears at which, according to the direction of rotation of the gears, the gear teeth of both gears get close and enter the meshing point (e.g., enter the mesh). When lubricating in-mesh, the lubricant contacts the gear teeth before the gear teeth mesh.

As used herein, the term “out-of-mesh” or “out-of-mesh side” refers to a location of a meshing between two gears at which, according to the direction of rotation of the gears, the gear teeth of both gears leave the meshing point (e.g., separate from the mesh). When lubricating out-of-mesh, the lubricant contacts the gears after the gear teeth have separated from the meshing point.

As used herein, “friction” of two rotating components occurs at the interface of contacts between the two rotating components and is the result of the contacts of the two rotating components sliding and rolling with respect to each other. The friction is a function of the geometrical configuration and operative conditions (e.g., transmitted power through the two rotating components).

As used herein, “windage” of a rotating component occurs due to the interaction of the rotating component with the fluids (e.g., air or lubricant) surrounding the rotating component. The windage is caused by drag of the rotating component within the fluids and is a function of the geometrical configuration and operative conditions. One of the main drivers of the windage is the amount of lubricant interacting with the rotating component.

As used herein, the terms “large” and “small” are used relative to one another for defining the size of a component or a space.

A gear assembly for a gas turbine featuring a fan drive gear system or for other applications is used to transmit power and motion from one rotating component to another rotating component. For example, a turbine engine can include a gearbox assembly that transmits power from a shaft of the turbo-engine to a fan of the turbine engine. Rotating parts (e.g., the gears), however, are not 100% efficient. During operation of the gear assembly, the gears and the bearings generate power losses due to friction (F) (e.g., between the gear teeth of the gears) and windage (W) due to the interaction of the rotating components with the fluids (e.g., lubricant) inside the gear assembly. The friction and the windage produce heat within the gear assembly that needs to be dissipated. Lubricant, such as, by way of a non-limiting example, oil, can be used to lubricate and to cool the gear assembly components (e.g., the gears and the bearings) through dedicated lubricant streams directed to the bearings and the meshing points of the gears.

When a jet engine is in a part-power condition, it is beneficial to reduce lubrication flow to the gearbox to reduce windage losses. Reducing lubrication flow reduces losses, due to the gear teeth interacting with less fluid, as compared to lubrication systems without the benefit of the present disclosure.

Some systems and methods of providing lubricant flow into a gearbox include a lubricant injector sending lubrication to the gears, the lubricant injector having orifices that are fixed in size. However, the orifices of a lubricant injector that are fixed in size may not provide an appropriate spray pattern for the gearbox, as an appropriate spray pattern for the gearbox when the turbine engine is, for example, in cruise may be different than an appropriate spray pattern for the gearbox when the turbine engine is, for example, accelerating.

To reduce windage losses when the turbine engine runs at a part-power condition, such as cruise, it may be beneficial to ensure that there is an appropriate spray pattern of lubrication to the gearbox commensurate with lubrication and cooling needs of the gears during the part-power condition. Thus, it may be beneficial to reduce lubrication flow to the gearbox when a turbine engine transitions from a high-power condition to a part-power condition or a low-power condition, so that there is less lubrication flow in a part-power condition or a low-power condition than when the turbine engine runs at a high-power condition. During a part-power condition, less lubricant is required in the gearbox, allowing for a reduction in windage losses. To reduce the amount of lubricant in the gearbox during a part-power condition, a variable valve may move extra lubricant back to the lubricant tank through a return line. However, with a reduction of lubricant entering the gearbox, there is a reduction of pressure in a spray of lubricant (a change in the spray pattern). To maintain the spray pattern between high-power conditions and low power conditions, the lubricant injector spraying onto the gearbox should have a similar jet speed over gear speed ratio (i.e., the jet speed over gear speed is about the same or is approximately the same) of lubricant exiting through orifices of the lubricant injector between each power condition, and the lubrication flow can be modulated by orifice sizes. The gear speed measured, for purposes of jet speed over gear speed, is the pitch line velocity (PLV). The pitch line velocity is represented by PLV=(π ω D)/60=(π ω m Z)/60, where ω is the angular velocity of a given gear sharing a mesh, D is the diameter of the given gear, Z is the number of teeth of the given gear, and m is the module of the given gear. The module of each gear (m=D/Z) is the same for two gears sharing a mesh. Given that the module of a pinion (mₚ) is equal to the module of a gear (m_{g}), shown by the relationship mₚ=m_{g}, a relationship PLVₚ=PLV_{g} may be derived. Because the sun gear, the planet gears, and the ring gear share meshes, each of the gears shares the same pitch line velocity and, thus, the pitch line velocity of any of the gears may be selected for establishing the gear speed. In other embodiments, gear speed may be interpreted to be angular velocity of a measured gear, provided that the measured gear is consistently measured when determining the jet speed over gear speed. Thus, during a part-power condition, when a portion of the lubricant is redirected to the lubrication tank to feed less lubricant to the gearbox, reducing the orifice size of the lubricant injector will increase the jet speed of the lubricant through the orifices. The reduced sizes of the orifices of the lubricant injector may be tailored to ensure that the jet speed over gear speed ratio of the lubricant through the orifices during a reduced power condition of the turbine engine is about equal to the jet speed over gear speed ratio of the lubricant through the orifices during a high-power condition when the lubricant injector does not have reduced-sized orifices.

The relationship of lubricant, Q, in relation to the velocity of spray, v, may be found in the relationship Q=v*pi*r², where r is the radius of the spray bar, the spray bar having circular-shaped holes. In embodiments, more generally, the velocity spray, v, may be generically represented by the formula Q=A*v, where A is the area of the holes. In embodiments where the velocity is held constant, reducing the radius r, and therefore the diameter d, has the effect of reducing the amount of lubricant that goes into the gearbox, meaning that some of the lubricant will flow outside of the gearbox, such as to the lubricant tank. The excess lubricant sent to the lubricant tank is redirected to the lubricant tank via the return line to the tank. In other embodiments, a centrifugal pump is used to modulate increments dP of pump back pressure (i.e., adjusting the lubricant flow into the gearbox Q as a function of back pressure dP. In the same formula, Q=v*pi*r², when the lubricant flow into the gearbox Q remains constant, yet the radius and diameter shrink, then the only remaining variable, velocity v, increases. dP=½*rho*v²*k, suggesting that the pump back pressure increases when velocity increases. Because a centrifugal pump reduces Q when reacting to increments of back pressure, a centrifugal pump system reduces the flow of lubricant into the gearbox automatically.

Due to the pressure differences when modulating the lubrication flow described above, one solution is having multiple orifice sizes in the lubricant injector, where lubricant flows through some or all orifices of the lubricant injector when the turbine engine runs at a high-power condition and where lubricant flows through a fewer number of orifices or a lesser total area of orifices when the turbine engine runs at a part-power condition or a low-power condition. While having multiple orifice sizes can be achieved by routing two different sets of lubrication lines into the gearbox individually, it is advantageous to have a single-package lubricant injector that receives lubricant from only one line and that has multiple orifice types, wherein orifices of one type have a different size from orifices of another type. Therefore, lubrication may be provided to the gearbox through one primary set of lubrication lines.

The orifices of the lubricant injector may be engaged by a lubricant control module that may cover certain orifices of the injector depending on the power condition of the turbine engine. The lubricant control module may be engaged by an actuator that is passively controlled in some systems and methods. On the other hand, the lubricant control module may be engaged by an actuator that is actively controlled in other systems and methods.

Other systems and methods may accomplish creating a variation in the size of the orifices and an amount of lubrication flow delivery without use of a lubricant control module, which could save on Full Authority Digital Engine Control (FADEC) input output (I/O), on cost (such as a cost for developing control logic for the FADEC and additional hardware required thereof), on packaging lubricant injectors, or any combination thereof.

Accordingly, the present disclosure provides for an improved lubrication control system for a turbine engine gear assembly in which lubricant flow may be shifted depending on which orifices, of a set of various orifice sizes, have lubricant exiting therethrough.

The lubrication control system for a turbine engine gear assembly of the present disclosure can be utilized in any type of gear assembly. In some embodiments, the lubrication control system is utilized for power gearboxes in which the gear speeds are high (e.g., the pitch line velocity (PLV) of the gears is greater than 65 m/s). The lubrication control system disclosed herein provides for increased gear performance, and, thus, decreased engine fuel consumption and overall engine weight, as compared to gear assemblies and engines without the benefit of the present disclosure.

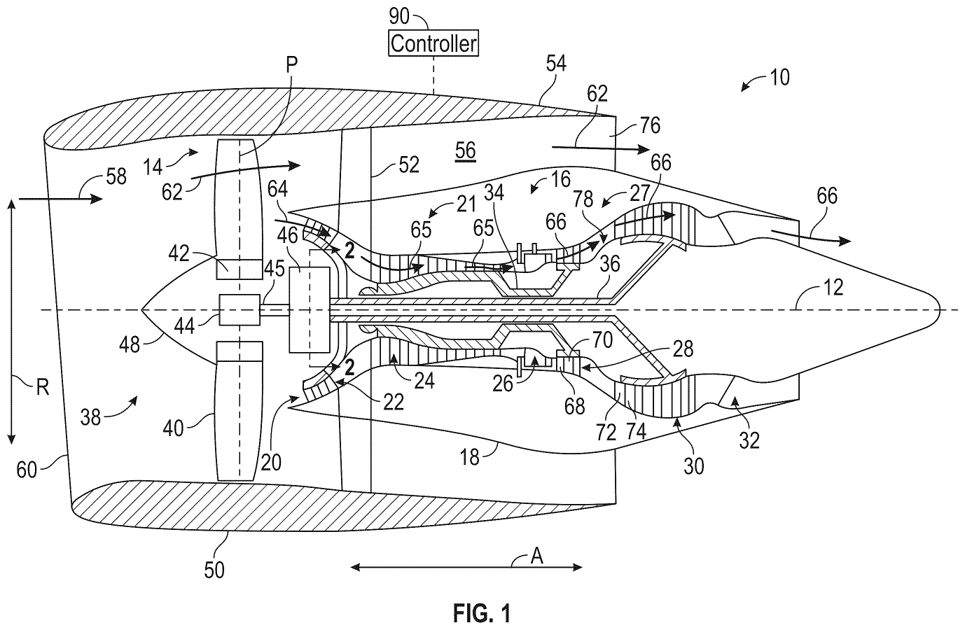

Referring now to the drawings, FIG. 1 is a schematic, cross-sectional diagram of a turbine engine 10, taken along a longitudinal centerline axis 12 of the turbine engine 10, according to an embodiment of the present disclosure. As shown in FIG. 1, the turbine engine 10 defines an axial direction A (extending parallel to the longitudinal centerline axis 12 provided for reference) and a radial direction R that is normal to the axial direction A. In general, the turbine engine 10 includes a fan section 14 and a turbo-engine 16 disposed downstream from the fan section 14.

The turbo-engine 16 includes, in serial flow relationship, a compressor section 21, a combustion section 26, and a turbine section 27. The turbo-engine 16 is substantially enclosed within an outer casing 18 that is substantially tubular and defines a core inlet 20 that is annular about the longitudinal centerline axis 12. As schematically shown in FIG. 1, the compressor section 21 includes a booster or a low pressure (LP) compressor 22 followed downstream by a high pressure (HP) compressor 24. The combustion section 26 is downstream of the compressor section 21. The turbine section 27 is downstream of the combustion section 26 and includes a high pressure (HP) turbine 28 followed downstream by a low pressure (LP) turbine 30. The turbo-engine 16 further includes a jet exhaust nozzle section 32 that is downstream of the turbine section 27, a high-pressure (HP) shaft 34 or a spool, and a low-pressure (LP) shaft 36. The HP shaft 34 drivingly connects the HP turbine 28 to the HP compressor 24. The HP turbine 28 and the HP compressor 24 rotate in unison through the HP shaft 34. The LP shaft 36 drivingly connects the LP turbine 30 to the LP compressor 22. The LP turbine 30 and the LP compressor 22 rotate in unison through the LP shaft 36. The compressor section 21, the combustion section 26, the turbine section 27, and the jet exhaust nozzle section 32 together define a core air flow path.

For the embodiment depicted in FIG. 1, the fan section 14 includes a fan 38 (e.g., a variable pitch fan) having a plurality of fan blades 40 coupled to a disk 42 in a spaced apart manner. As depicted in FIG. 1, the fan blades 40 extend outwardly from the disk 42 generally along the radial direction R. In the case of a variable pitch fan, the plurality of fan blades 40 are rotatable relative to the disk 42 about a pitch axis P by virtue of the fan blades 40 being operatively coupled to an actuation member 44 configured to collectively vary the pitch of the fan blades 40 in unison. The fan blades 40, the disk 42, and the actuation member 44 are together rotatable about the longitudinal centerline axis 12 via a fan shaft 45 that is powered by the LP shaft 36 across a power gearbox, also referred to as a gearbox or a gearbox assembly 46. In this way, the fan 38 is drivingly coupled to, and powered by, the turbo-engine 16, and the turbine engine 10 is an indirect drive engine. The gearbox assembly 46 is shown schematically in FIG. 1. The gearbox assembly 46 is a reduction gearbox assembly for adjusting the rotational speed of the fan shaft 45 and, thus, the fan 38 relative to the LP shaft 36 when power is transferred from the LP shaft 36 to the fan shaft 45.

Referring still to the exemplary embodiment of FIG. 1, the disk 42 is covered by a fan hub 48 that is aerodynamically contoured to promote an airflow through the plurality of fan blades 40. In addition, the fan section 14 includes an annular fan casing or a nacelle 50 that circumferentially surrounds the fan 38 and at least a portion of the turbo-engine 16. The nacelle 50 is supported relative to the turbo-engine 16 by a plurality of outlet guide vanes 52 that are circumferentially spaced about the nacelle 50 and the turbo-engine 16. Moreover, a downstream section 54 of the nacelle 50 extends over an outer portion of the turbo-engine 16, and, with the outer casing 18, defines a bypass airflow passage 56 therebetween.

During operation of the turbine engine 10, a volume of air 58 enters the turbine engine 10 through an inlet 60 of the nacelle 50 or the fan section 14. The pressure of core air 64 is then increased, generating compressed air 65. The compressed air 65 is routed through the HP compressor 24 and into the combustion section 26, where the compressed air 65 is mixed with fuel and ignited to generate combustion gases 66.

The combustion gases 66 are routed into the HP turbine 28 and expanded through the HP turbine 28 where a portion of thermal energy or kinetic energy from the combustion gases 66 is extracted via one or more stages of HP turbine stator vanes 68 and HP turbine rotor blades 70 that are coupled to the HP shaft 34. This causes the HP shaft 34 to rotate, thereby supporting operation of the HP compressor 24 (self-sustaining cycle). In this way, the combustion gases 66 do work on the HP turbine 28. The combustion gases 66 are then routed into the LP turbine 30 and expanded through the LP turbine 30. H ere, a second portion of the thermal energy or the kinetic energy is extracted from the combustion gases 66 via one or more stages of LP turbine stator vanes 72 and LP turbine rotor blades 74 that are coupled to the LP shaft 36. This causes the LP shaft 36 to rotate, thereby supporting operation of the LP compressor 22 (self-sustaining cycle) and rotation of the fan 38 via the gearbox assembly 46. In this way, the combustion gases 66 do work on the LP turbine 30.

The combustion gases 66 are subsequently routed through the jet exhaust nozzle section 32 of the turbo-engine 16 to provide propulsive thrust. Simultaneously, bypass air 62 is routed through the bypass airflow passage 56 before being exhausted from a fan nozzle exhaust section 76 of the turbine engine 10, also providing propulsive thrust. The HP turbine 28, the LP turbine 30, and the jet exhaust nozzle section 32 at least partially define a hot gas path 78 for routing the combustion gases 66 through the turbo-engine 16.

A controller 90 is in communication with the turbine engine 10 for controlling aspects of the turbine engine 10. For example, the controller 90 is in two-way communication with the turbine engine 10 for receiving signals from various sensors and control systems of the turbine engine 10 and for controlling components of the turbine engine 10, as detailed further below. The controller 90, or components thereof, may be located onboard the turbine engine 10, onboard the aircraft, or can be located remote from each of the turbine engine 10 and the aircraft. The controller 90 can be an FADEC that controls aspects of the turbine engine 10.

The controller 90 may be a standalone controller or may be part of an engine controller to operate various systems of the turbine engine 10. In this embodiment, the controller 90 is a computing device having one or more processors and a memory. The one or more processors can be any suitable processing device, including, but not limited to, a microprocessor, a microcontroller, an integrated circuit, a logic device, a programmable logic controller (PLC), an application specific integrated circuit (ASIC), or a Field Programmable Gate Array (FPGA). The memory can include one or more computer-readable media, including, but not limited to, non-transitory computer-readable media, a computer readable non-volatile medium (e.g., a flash memory), a RAM, a ROM, hard drives, flash drives, or other memory devices.

The memory can store information accessible by the one or more processors, including computer-readable instructions that can be executed by the one or more processors. The instructions can be any set of instructions or a sequence of instructions that, when executed by the one or more processors, cause the one or more processors and the controller 90 to perform operations. The controller 90 and, more specifically, the one or more processors are programmed or configured to perform these operations, such as the operations discussed further below. In some embodiments, the instructions can be executed by the one or more processors to cause the one or more processors to complete any of the operations and functions for which the controller 90 is configured, as will be described further below. The instructions can be software written in any suitable programming language or can be implemented in hardware. Additionally, or alternatively, the instructions can be executed in logically or virtually separate threads on the processors. The memory can further store data that can be accessed by the one or more processors.

The technology discussed herein makes reference to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

The turbine engine 10 depicted in FIG. 1 is by way of example only. In other exemplary embodiments, the turbine engine 10 may have any other suitable configuration. For example, in other exemplary embodiments, the fan 38 may be configured in any other suitable manner (e.g., as a fixed pitch fan) and further may be supported using any other suitable fan frame configuration. Moreover, in other exemplary embodiments, any other suitable number or configuration of compressors, turbines, shafts, or a combination thereof may be provided. In still other exemplary embodiments, aspects of the present disclosure may be incorporated into any other suitable turbine engine, such as, for example, turbofan engines, propfan engines, turbojet engines, turboprop, or turboshaft engines.

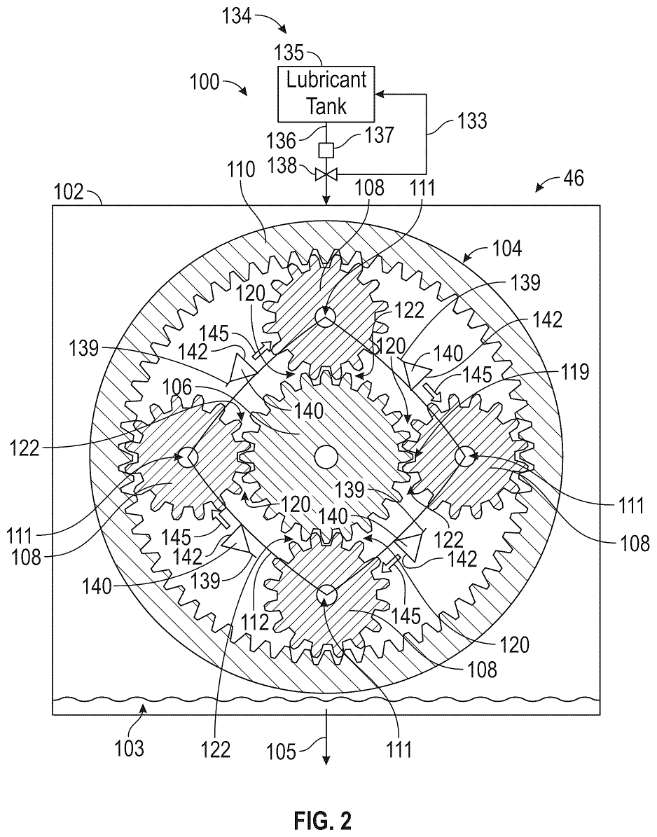

FIG. 2 is a schematic, cross-sectional view of a gearbox assembly taken along line 2-2 in FIG. 1 and a lubrication system, according to the present disclosure. The gearbox assembly 46 includes a housing 102 (e.g., shown schematically in FIG. 2), a sump 103 (shown schematically in FIG. 2), and a gear assembly 104. The sump 103 is a reservoir within the housing 102 that collects lubricant that drains from the gear assembly 104 or from the bearings of the gear assembly 104. The sump 103 includes a sump line 105 shown schematically by an arrow. The sump line 105 is for draining the lubricant from the sump 103.

The gear assembly 104 includes a first gear 106, one or more second gears 108, as shown there are four, and a third gear 110. The gear assembly 104 is exemplary and the embodiments of this disclosure are applicable to other gearbox configurations as well. In FIG. 2, the first gear 106 is a sun gear, the one or more second gears 108 are planet gears, and the third gear 110 is a ring gear. The gear assembly 104 is a star type or a rotating ring gear type gear assembly (e.g., the third gear 110 is rotating and a planet carrier 112 [shown schematically in FIG. 2] is fixed and stationary). In such an arrangement, the fan 38 (FIG. 1) is driven by the third gear 110. In this way, the third gear 110 is an output of the gear assembly 104. However, other suitable types of gear assemblies may be employed. In one non-limiting embodiment, the gear assembly 104 is a planetary arrangement, in which the third gear 110 is held fixed, with the planet carrier 112 allowed to rotate. In such an arrangement, the fan 38 is driven by the planet carrier 112. In this way, the one or more second gears 108 (e.g., the planet carrier 112) are the output of the gear assembly 104. In another non-limiting embodiment, the gear assembly 104 may be a differential gear assembly in which the third gear 110 and the planet carrier 112 are both allowed to rotate.

Radially outward of the first gear 106, and intermeshing therewith, is the one or more second gears 108 that are coupled together and supported by the planet carrier 112 (shown schematically). The first gear 106 and a respective second gear 108 are intermeshed at a mesh 119. The planet carrier 112 supports and constrains the one or more second gears 108 such that each of the one or more second gears 108 is enabled to rotate about its own corresponding axis without rotating about the periphery of the first gear 106. Radially outward of the one or more second gears 108, and intermeshing therewith, is the third gear 110, which is an annular ring gear. The third gear 110 rotates to drive rotation of the fan 38 (FIG. 1) about the longitudinal centerline axis 12 (FIG. 1).

In operation, the LP shaft 36 (FIG. 1) rotates and causes an input shaft to rotate, and the input shaft causes the first gear 106 to rotate in a first gear rotation direction. The first gear 106, being intermeshed with the one or more second gears 108, causes the one or more second gears 108 to rotate about their corresponding axis of rotation in a second gear rotation direction opposite of the first gear rotation direction. A location, at which the gear teeth of the first gear 106 and the gear teeth of the one or more second gears 108 begin to intermesh at the mesh 119 as the gears rotate, is referred to as an in-mesh side 120. A location, at which the gear teeth of the first gear 106 separate from the gear teeth of the one or more second gears 108 (e.g., separate from the mesh 119) as the gears rotate, is referred as an out-of-mesh side 122. The one or more second gears 108 each includes one or more bearings 111 disposed within the one or more second gears 108 and coupled to the planet carrier 112 such that the one or more second gears 108 rotate with respect to the one or more bearings 111. In embodiments in which the third gear 110 also rotates, the third gear 110 rotates in the same direction as the second gear rotation direction. The mesh between the gear teeth of the one or more second gears 108 and the third gear 110 also includes an in-mesh side 120 and an out-of-mesh side 122.

A lubrication system 100 includes a lubricant supply 134, a lubricant tank 135, a lubricant supply line 136, a lubricant pump 137, a valve 138, a return line 133, and one or more lubricant injectors 140 for supplying a lubricant 145 to the gear assembly 104, the lubricant 145 exiting from a face 142 of the lubricant injectors 140 onto second gears 108. In some embodiments, the lubrication system 100 includes at least two lubricant injectors 140. The lubricant supply 134 includes the lubricant tank 135 for storing lubricant (e.g., oil) therein and supplies the lubricant to the gear assembly 104 through the lubricant supply line 136. The lubricant tank 135 allows the lubricant 145 to be stored before being directed into the gearbox assembly 46. The lubricant pump 137 pumps the lubricant 145 out of the lubricant tank 135 and toward the valve 138. The amount of lubricant 145 entering the gearbox assembly 46 is controlled by the valve 138, which opens or closes (or partially opens) due to conditions such as pressure levels to ensure that an oversupply of the lubricant 145 does not occur in the gearbox assembly 46. Excess lubricant that does not pass through the valve 138 runs through the return line 133 connected to the valve 138, and the return line 133 returns the excess lubricant back to the lubricant tank 135. The lubricant 145 that passes through the valve 138 enters the gearbox assembly 46 and flows through a feed line 139 to a respective lubricant injector 140. In some embodiments, the lubricant supply 134 can include one or more sumps such that the lubricant 145 is circulated through the lubrication system 100 from the sumps, for example, in addition to, or without, the use of the lubricant tank 135.

The one or more lubricant injectors 140 are in fluid communication with the lubricant supply line 136 such that the lubricant supply 134 supplies the lubricant to the one or more lubricant injectors 140 through the lubricant supply line 136, wherein each lubricant injector receives lubricant from the feed line 139. In some embodiments, the lubrication system 100 supplies the lubricant from the lubricant supply 134 to the one or more lubricant injectors 140 without a lubricant pump 137, for example, by gravity or by centrifugal force due to rotation of the planet carrier 112 in the planetary configuration of the gear assembly 104. The lubricant 145 drains from the gear assembly 104 and into the sump 103. The lubricant in the sump 103 is drained from the sump 103 through the sump line 105. The sump line 105 redirects the lubricant to the lubricant tank 135 by a scavenge pump. The lubricant drained through the sump 103 is filtered and cooled before being reintroduced to the lubricant supply 134. In this way, the lubricant can be re-used to lubricate the gears of the gear assembly 104, the bearings of the gear assembly 104, other components of the gearbox assembly 46, or other components of the turbine engine 10 (FIG. 1).

The lubricant injectors 140 direct lubricant 145 to the first gear, the second gear, or both. In some embodiments, each of the lubricant injectors 140 sprays lubricant 145 onto a respective second gear. In some embodiments, each of the lubricant injectors 140 sprays lubricant 145 onto a portion of the first gear. In some embodiments, the lubricant injectors 140 spray lubricant 145 into a respective in-mesh side 120 such that the lubricant 145 flows from the in-mesh side 120 to the out-of-mesh side 122 of each mesh 119 between each second gear 108 and the first gear 106.

A total mass flow rate (\dot{m}_{lubricant_total}) of the lubricant within the one or more lubricant injectors 140 is controlled by the lubricant pump 137. The total mass flow rate (\dot{m}_{lubricant_total}) is a function of the power loss due to friction (F) and the power loss due to windage (W). In particular, the total mass flow rate (\dot{m}_{lubricant_total}) is equal to a first mass flow rate (\dot{m}_{lubricant_friction}) summed with a second mass flow rate (\dot{m}_{lubricant_windage}). The first mass flow rate (\dot{m}_{lubricant_friction}) is determined based on the power loss due to friction (F) and the second mass flow rate (\dot{m}_{lubricant_windage}) is determined based on the power loss due to windage (W), as detailed further below.

The first mass flow rate (\dot{m}_{lubricant_friction}) is a function of the power loss due to friction (F), for example, at the mesh 119 (e.g., between the gear teeth of the first gear 106 and of the second gear 108), the specific heat capacity (Cₚ) of the lubricant, and the maximum temperature (dT) that the first gear 106 and the second gear 108 (e.g., at the mesh) can withstand before becoming damaged (e.g., based on material properties of the first gear 106 and the second gear 108). The friction F takes into account friction for all components in the gearbox. The first mass flow rate is given by relationship (1):

$${\dot{m}}_{lubricant \_ friction} = \frac{F}{( {C}_{p} * dT )} \qquad ( 1 )$$

The power loss due to the friction (F) is a function of the turbine engine size. The specific heat capacity (Cₚ) and the maximum delta temperature (dT) are functions of the lubricant type and the temperature generated within the gear assembly 104. In a non-limiting example, the power loss due to friction is in a range from one kilowatt to one hundred kilowatts (1 kW to 100 kW), the specific heat capacity (C p) is in a range from one thousand Joules per kilogram Kelvin to three thousand Joules per kilogram Kelvin (1000 J/kg*K to 3000 J/kg*K), and the maximum delta temperature (dT) is from one degree Celsius to sixty degrees Celsius (1 °C to 60 °C).

The second mass flow rate (\dot{m}_{lubricant_windage}) is a function of the power loss due to windage (W), for example, at the mesh 119 (e.g., between the rotating gears and the fluid surrounding the gears in the gearbox), the specific heat capacity (Cₚ) of the lubricant, and the maximum temperature (dT) that the gears experience in the gearbox. The windage W takes into account windage losses for all rotating gears in the gearbox. The second mass flow rate is given by relationship (2):

$${\dot{m}}_{lubricant \_ windage} = \frac{W}{( {C}_{p} * dT )} \qquad ( 2 )$$

The power loss due to the windage (W) is a function of the turbine engine size. The specific heat capacity (Cₚ) and the maximum delta temperature (dT) are functions of the lubricant type and the temperature generated within the gear assembly 104.

In a non-limiting example, the power loss due to windage is in a range from one kilowatt to one hundred kilowatts (1 kW to 100 kW), the specific heat capacity (C p) is in a range from one thousand Joules per kilogram Kelvin to three thousand Joules per kilogram Kelvin (1000 J/kg*K to 3000 J/kg*K), and the maximum delta temperature (dT) is from one degree Celsius to sixty degrees Celsius (1 °C to 60 °C).

The total mass flow rate is in a range from zero point one kilograms per second to five kilograms per second (0.1 kg/s to 3 kg/s). The ranges provided herein are exemplary only, and the values of the friction, the specific heat capacity, the maximum delta temperature, and the first mass flow rate can vary from the ranges (e.g., higher or lower than the ranges) provided based on specific applications, lubricant types, or engine sizes. The total mass flow rate for the lubricant is shown by relationship (3):

$${\dot{m}}_{lubricant} = \frac{F + W}{( {C}_{p} * dT )} = {\dot{m}}_{lubricant \_ friction} + {\dot{m}}_{lubricant \_ windage} \qquad ( 3 )$$

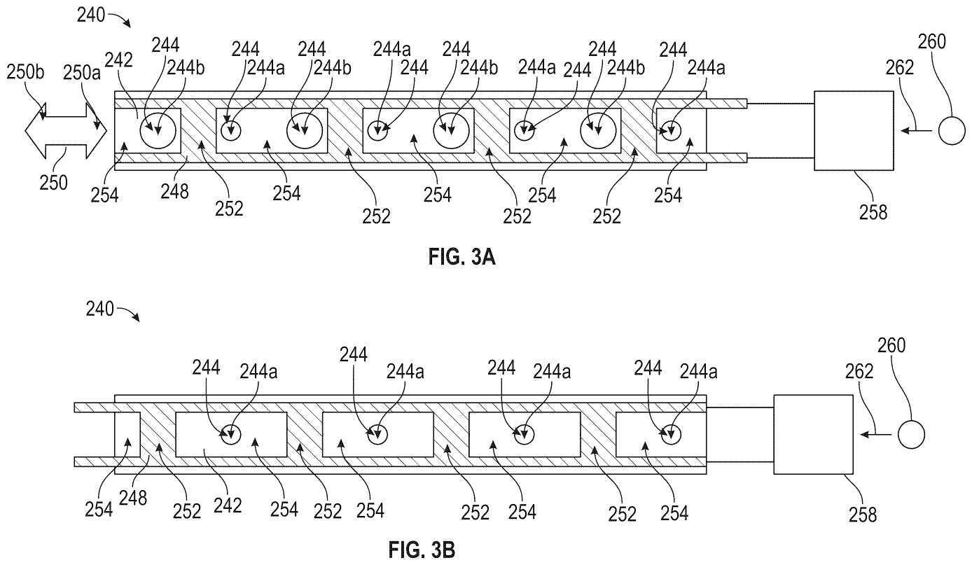

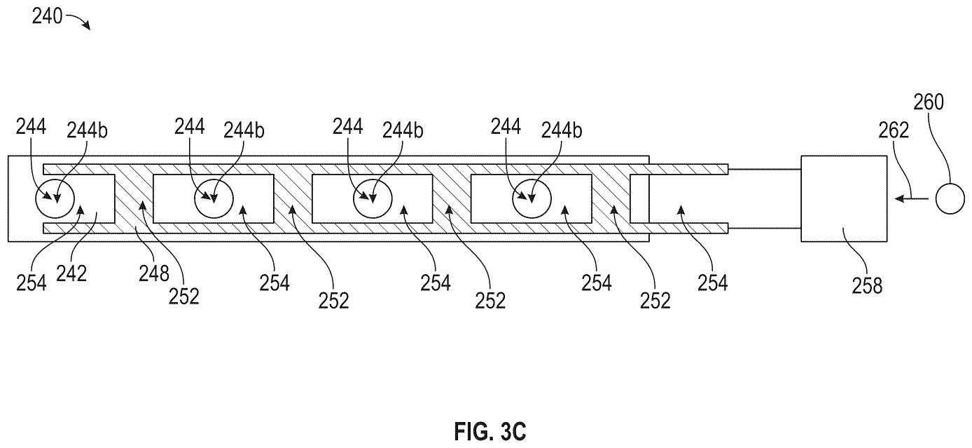

FIG. 3A is a schematic, cross-sectional view of a variable-orifice injector face 242 for a lubrication control system of a turbine engine gear assembly of a variable-orifice lubricant injector 240, according to the present disclosure. The variable-orifice lubricant injector 240 has orifices 244 in the variable-orifice injector face 242 of the variable-orifice lubricant injector 240, including two or more orifices 244 through which lubricant flows onto one or more gears of the gear assembly 104 (FIG. 1). The orifices 244 are of varying sizes. The orifices 244 of the variable-orifice lubricant injector 240 include one or more first orifice type 244a and one or more second orifice type 244b, and lubricant may flow through orifices 244 of each of the first orifice type 244a and the second orifice type 244b. The first orifice type 244a and the second orifice type 244b are distinguished by the size, the shape, the angle, or any combination thereof. In FIG. 3A, the first orifice type 244a and the second orifice type 244b are distinguished by size, so that the first orifice type 244a has a different size than that of the second orifice type 244b. For example, the first orifice type 244a may have a smaller size than that of the second orifice type 244b, or the first orifice type 244a may have a lesser diameter than that of the second orifice type 244b. Further, the first orifice type 244a may have a first output that is less than that of a second output of the second orifice type 244b due to the smaller size of the first orifice type 244a than that of the second orifice type 244b. In other embodiments, the first orifice type 244a may have a first output that is greater than that of a second output of the second orifice type 244b due to the greater size of the first orifice type 244a than that of the second orifice type 244b.

In some embodiments, the variable-orifice lubricant injector 240 may include two or more orifices 244, including orifices of the first orifice type 244a and the second orifice type 244b. In some embodiments, the variable-orifice lubricant injector 240 may include a plurality of four or more orifices 244, including at least one orifice 244 of the second orifice type 244b and more than one orifice of the first orifice type 244a, or including at least one orifice 244 of the first orifice type 244a and more than one orifice 244 of the second orifice type 244b. The orifices 244 of the plurality of orifices 244 are side by side without any intervening orifices. In some embodiments, the plurality of orifices 244 extends along the variable-orifice lubricant injector 240 so that a single straight line may be drawn approximately through the center of each orifice of the plurality of orifices 244. In some embodiments, the plurality of orifices 244 is arranged such that orifices of the second orifice type 244b and orifices of the first orifice type 244a extend in a repeating pattern along the variable-orifice lubricant injector 240, the repeating pattern repeating at least twice. The pattern may be alternating by first (F) and second (S)—such as, for example, F-S- for two or more alternations, such as, for example, F-S-F-S-F-S. In other embodiments, other repeating patterns with different alternations may be used.

Embodiments where orifices of the first orifice type 244a and the second orifice type 244b alternate can be advantageous to allow for a more uniform spray of lubricant 145 (FIG. 2) from the variable-orifice lubricant injector 240 than embodiments where orifices of the first orifice type 244a and the second orifice type 244b do not alternate, because covering all orifices of the first orifice type 244a or the second orifice type 244b will block the lubricant 145 from flowing through the portion(s) of the variable-orifice injector face 242 where orifices of the first orifice type 244a or the second orifice type 244b are positioned. In some embodiments, the repeating pattern extends along the variable-orifice lubricant injector 240 from end to end (i.e., from one end of the variable-orifice lubricant injector 240 to another end of the variable-orifice lubricant injector 240). In some embodiments, the plurality of orifices 244 includes three or more orifice types-such as, for example, a first orifice type, a second orifice type size, and a third orifice type, wherein the first orifice type is the smallest, the second orifice type is the largest, and the third orifice type is sized between the first orifice type and second orifice type. In some embodiments, at least one orifice directs at least some lubricant tangentially to a surface of the second gear 108 (FIG. 2). In some embodiments, at least one orifice directs at least some lubricant toward the mesh 119 (FIG. 2).

In some embodiments, one or more orifices 244 of the first orifice type 244a and one or more orifices 244 of the second orifice type 244b of the variable-orifice lubricant injector 240 receive the lubricant 145 (FIG. 2) from a same feed line 139 (FIG. 2). The variable-orifice lubricant injector 240 then directs the lubricant 145 through the orifices 244 of the variable-orifice lubricant injector 240, so that the lubricant 145 exits the orifices 244 as a flow of lubricant 145. In other embodiments, all the orifices 244 of the plurality of orifices 244 of the variable-orifice lubricant injector 240 receive lubricant from the same feed line 139.

The variable-orifice lubricant injector 240 includes a lubricant control module 248. The lubricant control module 248 slidably moves in a first direction 250a and a second direction 250b of a control-module directional arrow 250. The lubricant control module 248 includes a control-module covering bar 252 that covers at least one orifice 244. The lubricant control module 248 includes a control-module opening 254 that allows lubricant flowing from an orifice 244 to flow past the lubricant control module 248 and to the gears of the gear assembly 104. In some embodiments, the lubricant control module 248 includes at least two control-module covering bars 252. In some embodiments, the lubricant control module 248 includes at least three control-module covering bars 252. In some embodiments, the lubricant control module 248 includes at least three control-module openings 254. In some embodiments, the lubricant control module 248 includes at least four control-module openings 254.

FIG. 3B is a schematic, cross-sectional view of the face 242 of the variable-orifice lubricant injector 240 in FIG. 3A after the lubricant control module 248 has moved in the first direction 250a (FIG. 3A), according to the present disclosure. FIG. 3C is a schematic, cross-sectional view of the face 242 of the variable-orifice lubricant injector 240 in FIG. 3A after the lubricant control module 248 has moved in the second direction 250b (FIG. 3A), according to the present disclosure. In FIG. 3B, the control-module covering bars 252 cover the orifices 244 of the second orifice type 244b such that the flow of lubricant 145 (FIG. 2) only exits the orifices 244 of the first orifice type 244a. Whereas, in FIG. 3C, the control-module covering bar 252 covers the orifices 244 of the first orifice type 244a such that a flow of lubricant only exits the orifices 244 of the second orifice type 244b.

In some embodiments, the lubricant control module 248 moves to cover all of the orifices 244 of the second orifice type 244b at one position. In some embodiments, the lubricant control module 248 moves to cover all of the orifices 244 of the first orifice type 244a at one position. In some embodiments, the lubricant control module 248 moves to cover only some of the orifices 244 of the second orifice type 244b atone position. In some embodiments, the lubricant control module 248 moves to cover only some of the orifices 244 of the first orifice type 244a at one position. In some embodiments, the lubricant control module 248 does not cover any of the orifices 244 of the second orifice type 244b at one position. In some embodiments, the lubricant control module 248 does not cover any of the orifices 244 of the first orifice type 244a at one position. In some embodiments, the lubricant control module 248 moves to cover all of the orifices 244 of the second orifice type 244b and some of the orifices 244 of the first orifice type 244a at one position. In some embodiments, the lubricant control module 248 moves to cover all of the orifices 244 of the second orifice type 244b and none of the orifices 244 of the first orifice type 244a at one position. In some embodiments, the lubricant control module 248 moves to cover some of the orifices 244 of the second orifice type 244b and none of the orifices 244 of the first orifice type 244a at one position. In some embodiments, the lubricant control module 248 moves to cover all of the orifices 244 of the first orifice type 244a and some of the orifices 244 of the second orifice type 244b at one position. In some embodiments, the lubricant control module 248 moves to cover all of the orifices 244 of the first orifice type 244a and none of the orifices 244 of the second orifice type 244b at one position. In some embodiments, the lubricant control module 248 moves to cover some of the orifices 244 of the first orifice type 244a and none of the orifices 244 of the second orifice type 244b at one position. In some embodiments, the lubricant control module 248 moves to cover some of the orifices 244 of the second orifice type 244b and some of the orifices 244 of the first orifice type 244a, the lubricant control module 248 covering more of the orifices 244 of the second orifice type 244b than the orifices 244 of the first orifice type 244a, more of the orifices 244 of the first orifice type 244a than the orifices 244 of the second orifice type 244b, or an equal number of the orifices 244 of the first orifice type 244a and the orifices 244 of the second orifice type 244b.

In some embodiments, there is one orifice, such as one oval shaped orifice, rectangular shaped orifice, or oblique orifice. Thus, in embodiments, the lubricant control module 248 partially covers the one orifice to modulate the flow of fluid through the one orifice, such as when the engine is in a part-power condition. In other embodiments, the lubricant control module 248 leaves the orifice uncovered during a high-power condition when a flow of lubricant (and, hence, pressure of the lubricant flow) is greater.

A sensor 260 senses a condition of the turbine engine and produces a sensor output 262. In some embodiments, the sensor 260 senses pressure at the supply line (including air pressure and hydraulic pressure), temperature in the gearbox assembly 46 (FIG. 2) (such as, for example, temperature at an outlet of the gearbox assembly 46), torque in the inlet of the LP shaft, speed (such as, for example, speed of the pump for the HP shaft), or any combination of the aforementioned temperature, pressure, torque, and speed. In some embodiments, the sensor 260 is more specifically located inside the gearbox assembly 46, at an inlet of the gearbox assembly 46, at an outlet of the gearbox assembly 46, or at the lubricant supply line 136 (see FIG. 2). In some embodiments, the sensor 260 will sense higher pressure, higher temperature, or both higher pressure and higher temperature when the engine is in a high-power operation condition than the sensor 260 will sense when the engine is in a low-power operating condition or a mid-level-power operating condition. In some embodiments, the sensor 260 will sense lower pressure, lower temperature, or both lower pressure and lower temperature when the engine is in a low-power operation condition than the sensor 260 will sense when the engine is in a high-power operating condition or a mid-level-power operating condition. In some embodiments, the sensor 260 will sense a lower amount of pressure and temperature when the engine is in a mid-level-power operating condition than the sensor 260 will sense when the engine is in a high-power operating condition, and the sensor 260 will sense a higher amount of pressure and temperature when the engine is in a mid-level-power operating condition than the sensor 260 will sense when the engine is in a low-power operating condition. In some embodiments, the sensor 260 provides sensor information to the controller 90 (FIG. 1) as a sensor output. In other embodiments, the sensor 260 provides sensed information to an actuator 258 as a sensor output. In other embodiments, the sensor 260 is included in the controller 90 so that the controller 90 acquires sensed information and controls the actuator 258 based on the sensed information. In some embodiments, the turbine engine or the gearbox includes a plurality of sensors sensing conditions as noted above. In some embodiments, the pressure at the supply line has one or more predefined thresholds to determine how many orifices are covered at a time, the temperature in the gearbox has one or more predefined thresholds to determine how many orifices are covered at a time, or the pressure at the supply line and the temperature in the gearbox each have one or more predefined thresholds to determine how many orifices are covered at a time. For example, a high-power operating condition is achieved when pressure at the supply line exceeds a predefined threshold for pressure at the supply line, and a mid-level-power operating condition or a low-power operation condition is achieved when pressure at the supply line is lower than a predefined threshold for pressure at the supply line. In another example, a high-power operating condition is achieved when temperature in the gearbox exceeds a predefined threshold for temperature in the gearbox, and a mid-level-power operating condition or a low-power operation condition is achieved when temperature in the gearbox is lower than a predefined threshold for temperature in the gearbox.

The actuator 258 moves the lubricant control module 248. The actuator 258 may move the lubricant control module 248 to cover one or more orifices 244 based on a function of pressure or a flow rate of the lubricant. The actuator 258 may be an active actuator, the active actuator being controlled by the controller 90 (FIG. 1) and slidably moving the lubricant control module 248 based on an input from the sensor 260 in communication with the controller 90. The controller 90 may control the active actuator when an operator of the turbine engine activates a switch or a button that instructs the active actuator to slidably move the lubricant control module 248 in a first direction 250a or a second direction 250b based on output of the controller 90 (i.e., input to the active actuator from the controller 90). In some embodiments, the actuator 258 moves the lubricant control module 248 in a first direction 250a or a second direction 250b to fully cover one or more orifices 244. In some embodiments, the actuator 258 moves the lubricant control module 248 in a first direction 250a or a second direction 250b to partially cover or fully cover one or more orifices 244.

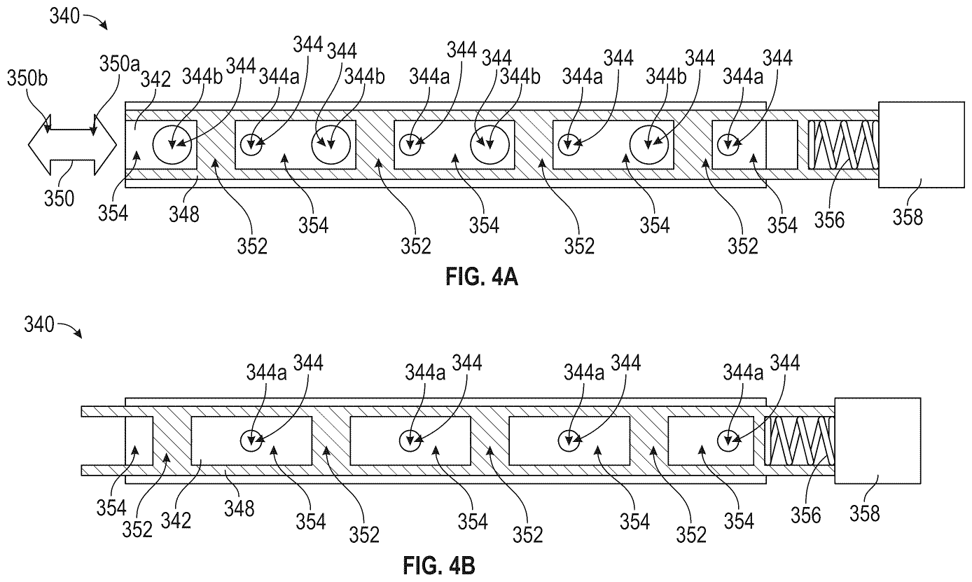

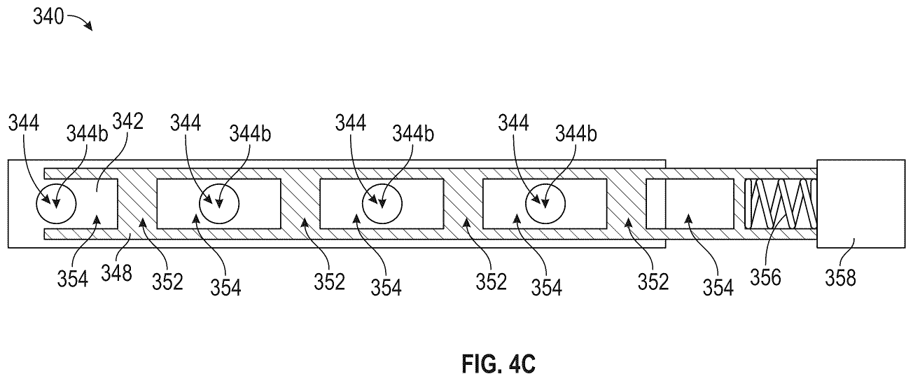

FIG. 4A is a schematic, cross-sectional view of a variable-orifice injector face 342 of a variable-orifice lubricant injector 340 for a lubrication control system of a turbine engine gear assembly, according to the present disclosure. The variable-orifice lubricant injector 340 is substantially similar to the variable-orifice lubricant injector 240 shown in FIG. 3. The same reference numerals or similar reference numerals will be used for components of the variable-orifice lubricant injector 340 that are the same as or similar to the components of the variable-orifice lubricant injector 240 discussed above. The description of these components above also applies to this embodiment, and a detailed description of these components is omitted here.

The variable-orifice lubricant injector 340 includes orifices 344 in the variable-orifice injector face 342 of the variable-orifice lubricant injector 340. The orifices 344 are of a first orifice type 344a or a second orifice type 344b. The variable-orifice lubricant injector 340 includes a lubricant control module 348 that slidably moves over some of the orifices 344 to regulate lubricant flow to the gears of the gear assembly 104 (FIG. 2), the lubricant control module 348 including at least one control-module covering bar 352 and at least one control-module opening 354. The lubricant control module 348 slidably moves in a first direction 350a and a second direction 350b of a control-module directional arrow 350.

FIG. 4B is a schematic, cross-sectional view of the face 342 of the variable-orifice lubricant injector 340 in FIG. 4A after the lubricant control module 348 has moved in the first direction 350a (FIG. 4A), according to the present disclosure. FIG. 4C is a schematic, cross-sectional view of the face 342 of the variable-orifice lubricant injector 340 in FIG. 4A after the lubricant control module 348 has moved in the second direction 350b (FIG. 4A), according to the present disclosure. In FIG. 4B, the control-module covering bar 352 covers the orifices 344 of the second orifice type 344b such that a flow of lubricant only exits the orifices 344 of the first orifice type 344a. Whereas, in FIG. 4C, the control-module covering bar 352 covers the orifices 344 of the first orifice type 344a such that a flow of lubricant only exits the orifices 344 of the second orifice type 344b.

The lubricant control module 348 of FIGS. 4A, 4B, and 4C is connected to a passive actuator. The passive actuator passively varies lubricant flow based on pressure experienced by the passive actuator at an inlet of the gearbox assembly 46 (FIG. 2). A signal line is positioned at the feed line 139 (FIG. 2), at a point where the lubricant supply line 136 (FIG. 2) splits into multiple feed lines 139 toward the inlet of the gearbox assembly 46 and indicates a reference pressure at the inlet of the gearbox assembly 46. The reference pressure may be hydraulic pressure or a combination of hydraulic pressure and air pressure. The reference pressure may be directly or indirectly affected by the power condition of the turbine engine 10. In some embodiments, high pressure may be when the pressure value at the inlet of a network is greater than eight (8) bar(d) or greater than ten (10) bar(d). Low pressure may be when the pressure value at the inlet of a network is less than three (3) bar(d) or less than two (2) bar(d). The level of normal pressure, however, depends on the operative condition of the turbine engine. In some embodiments, the reference pressure indicates whether the lubricant control module 348 should cover the orifices 344 (at low pressure) or not cover the orifices 344 (at high pressure). Thus, the passive actuator passively moves the lubricant control module 348 depending on, for instance, hydraulic pressure or both hydraulic pressure and air pressure sensed by the passive actuator. In some embodiments, when the passive actuator receives a high pressure from the signal line, the passive actuator moves the lubricant control module to not cover any orifices 344. In some embodiments, when the passive actuator receives a low pressure from the signal line, the passive actuator moves the lubricant control module 348 over orifices 344 of the second orifice type 344b. In some embodiments, the passive actuator may be a pneumatic actuator or a hydraulic actuator. In FIGS. 4A to 4C, the lubricant control module 348 is connected to a spring actuator 358 by a spring 356. The spring 356, thus, slidably moves the lubricant control module 348 based on an operating condition of the turbine engine 10. In some embodiments, a control-module opening 354 at one end of the lubricant control module 348 partially or fully contains the spring 356 in a plane of the first direction 350a and the second direction 350b of the control-module directional arrow 350. In other embodiments, the lubricant control module 348 is connected to an actuator that uses a wax element to move a piston of the actuator. Therefore, a high scavenge value T_{high} of the gearbox will cause the wax element to be liquid, leading to one position of the lubricant control module 348. And, a low value T_{low} of the gearbox will cause the wax element to be solid, leading to another position of the lubricant control module 348.

The variable-orifice lubricant injectors 240 and 340 provide for controlling the spray pattern of lubricant 145 (FIG. 2) onto the gears of the gearbox assembly 46 (FIG. 2). The orifices 244 and 344 of the variable-orifice lubricant injectors 240 and 340 being of variable size allows for the lubricant control modules 248 and 348 to regulate the flow of lubricant to the gearbox assembly 46 depending on the operating condition of the turbine engine 10 (FIG. 1). For example, the lubricant control module 248 and 348 moves in a first direction of the control-module directional arrow 250 and 350 and covers the orifices 244 and 344 of the second orifice type 244b and 344b when an increased lubricant jet speed of lubricant through the orifices is desired due to the turbine engine 10 running at a part-power condition. And, during a high-power condition, the lubricant control module 248 and 348 moves in a second direction of the control-module directional arrow 250 and 350 to uncover the orifices 244 and 344 of the second orifice type 244b and 344b to provide a similar jet speed over gear speed ratio of the lubricant exiting through the orifice during a high-power condition as the jet speed over gear speed ratio of the lubricant exiting through the orifice during the part-power condition. In this way, the variable-orifice lubricant injectors 240 and 340 provide for modulating the spray pattern of lubricant needed to be supplied to gears of the gear assembly 104 (FIG. 2) to adequately lubricate and to cool the gear assembly 104 pursuant to needs of the turbine engine 10 based on a given power condition of the turbine engine 10. In this way, the total mass flow rate of the lubricant through the variable-orifice lubricant injectors 240 and 340 can be reduced without detrimental effects on the spray pattern of the variable-orifice lubricant injectors 240 and 340, unlike what is seen for lubrication control systems without the benefit of the present disclosure. Accordingly, the variable-orifice lubricant injectors 240 and 340 provide for increased efficiency of the gear assembly 104 as compared to gear assemblies without the benefit of the present disclosure, as detailed above.

Further aspects are provided by the subject matter of the following clauses.

A lubrication control system for a gear assembly of a gearbox in a turbine engine. The lubrication control system comprises, a lubricant supply including a lubricant supply line to feed lubricant to the gearbox, a plurality of sensors sensing conditions within the turbine engine and producing sensor outputs, an active actuator that receives the sensor outputs to determine a power condition of the turbine engine and to produce an actuator output, a lubricant injector providing the lubricant to the gear assembly, and a lubricant control module receiving the actuator output. The lubricant injector includes a plurality of orifices including a first orifice type providing a first output and a second orifice type providing a second output greater than the first output, wherein the plurality of orifices receives lubricant from a same feed line, the lubricant exits through the plurality of orifices as a flow of lubricant, and the plurality of orifices directs the lubricant to the gear assembly. The lubricant control module is configured to slidably cover the first orifice type or the second orifice type, depending on the power condition of the turbine engine, to change the flow of lubricant.

The lubrication control system of the preceding clause, wherein the lubricant control module is movable to cover (a) some orifices of the first orifice type and no orifices of the second orifice type at a first position, (b) some orifices of the second orifice type and no orifices of the first orifice type at a second position, or (c) no orifices of the first orifice type and no orifices of the second orifice type at a third position.

The lubrication control system of any preceding clause, wherein the lubricant control module is configured to cover the first orifice type or the second orifice type depending on a power condition of the turbine engine, the power condition being determined by engine conditions experienced by a passive actuator or engine conditions sensed by one or more sensors in communication with a controller controlling an active actuator.

The lubrication control system of any preceding clause, wherein the lubricant control module slidably moves to cover all orifices of the first orifice type during a part-power condition.

The lubrication control system of any preceding clause, further comprising the active actuator, wherein the active actuator slidably moves the lubricant control module based on the power condition of the turbine engine, the power condition being sensed by sensors of a controller, the controller operable to actuate the actuator.

The lubrication control system of any preceding clause, further comprising the passive actuator, wherein the power condition of the turbine engine directly or indirectly affects a pressure near the passive actuator, the pressure actuating the passive actuator when the pressure is above a pressure threshold.

The lubrication control system of any preceding clause, wherein the lubricant control module is slidably movable in a first direction and a second direction, the lubricant control module including at least one control-module covering bar and at least one control-module opening.

The lubrication control system of any preceding clause, wherein the lubricant supply includes a return line sending excess lubricant to a lubricant tank during a part-power condition or a low-power condition.

The lubrication control system of any preceding clause, wherein the lubricant control module includes two control-module covering bars.

The lubrication control system of any preceding clause, wherein the plurality of orifices has at least four orifices, and the plurality of orifices is arranged such that one or more orifices of the first orifice type and one or more orifices of the second orifice type extend along the lubricant injector from end to end in a repeating pattern.

The lubrication control system of any preceding clause, wherein the lubricant control module covers at least some orifices of the plurality of orifices when the power condition decreases.

The lubrication control system of any preceding clause, wherein the sensor outputs are measurements of pressure at the lubricant supply line or temperature in the gearbox.

The lubrication control system of any preceding clause, wherein the active actuator slidably moves the lubricant control module based on an input from a controller, wherein the input from the controller is based upon the pressure at the lubricant supply line or the temperature in the gearbox.

The lubrication control system of any preceding clause, wherein the active actuator slidably moves the lubricant control module over some orifices of the plurality of orifices after the pressure at the lubricant supply line drops below a predefined pressure threshold or the temperature in the gearbox drops below a predefined temperature threshold.

A method of controlling lubricant flow to a gear assembly of a gearbox in a turbine engine. The method comprises providing a lubricant supply including a lubricant supply line to feed lubricant to the gearbox, providing a plurality of sensors sensing conditions within the turbine engine and producing sensor outputs, providing an active actuator that receives the sensor outputs from the plurality of sensors to determine a power condition of the turbine engine and that produces an actuator output, providing the lubricant to the gear assembly via a lubricant injector, receiving the actuator output by a lubricant control module, and slidably moving a lubricant control module, via an actuator, to cover the first orifice type or the second orifice type to change the flow of lubricant. The lubricant injector includes a plurality of orifices including a first orifice type providing a first output and a second orifice type providing a second output greater than the first output. The plurality of orifices receives lubricant from a same feed line, the lubricant exits through the plurality of orifices as a flow of lubricant, and the plurality of orifices directs the lubricant to the gear assembly.

The method of the preceding clause, further comprising slidably moving the lubricant control module to cover the first orifice type or the second orifice type depending on a power condition of the turbine engine, the power condition being determined by engine conditions experienced by a passive actuator or engine conditions sensed by one or more sensors in communication with a controller controlling an active actuator.

The method of the preceding clause, further comprising slidably moving the lubricant control module to cover all orifices of the first orifice type during a part-power condition.

The method of the preceding clause, further comprising slidably moving, via a passive actuator, the lubricant control module over some orifices of the plurality of orifices after pressure at the lubricant supply line drops below a predefined pressure threshold or a temperature at an outlet of the gearbox drops below a predefined temperature threshold.

The method of the preceding clause, further comprising slidably moving the lubricant control module to cover (a) some orifices of the first orifice type and no orifices of the second orifice type at one position, (b) some orifices of the second orifice type and no orifices of the first orifice type at another position, or (c) no orifices of the first orifice type and no orifices of the second orifice type at a third position.

The method of any preceding clause, further comprising slidably moving the lubricant control module to cover all orifices of the first orifice type during a part-power operating condition.

The method of any preceding clause, further comprising slidably moving the lubricant control module in a first direction and a second direction, the lubricant control module including at least one control-module covering bar and at least one control-module opening.

The method of any preceding clause, further comprising arranging the plurality of orifices such that one or more orifices of the first orifice type and one or more orifices of the second orifice type extend along the lubricant injector from end to end in a repeating pattern.

The method of any preceding clause, further comprising covering, with the lubricant control module, at least some orifices of the plurality of orifices when the power condition decreases.

The method of any preceding clause, further comprising sensing, with the sensors, pressure at the lubricant supply line or temperature in the gearbox.

The method of any preceding clause, wherein the turbine engine further comprises an HP shaft and an LP shaft, the method further comprising slidably moving the lubricant control module with the active actuator based on an input from a controller, wherein the input from the controller is based upon speed of the turbine engine, torque of the HP shaft, or torque of the LP shaft.

The method of any preceding clause, the method further comprising slidably moving the lubricant control module with the active actuator based on an input from a controller, wherein the input from the controller is based upon pressure at the lubricant supply line or temperature in the gearbox.

The method of any preceding clause, further comprising slidably moving the lubricant control module over some orifices of the plurality of orifices after the pressure at the lubricant supply line drops below a predefined pressure threshold or the temperature in the gearbox drops below a predefined temperature threshold.

A turbine engine having a lubrication control system for a gear assembly of a gearbox of the turbine engine. The lubrication control system comprises a lubricant supply including a lubricant supply line to feed lubricant to the gearbox, a passive actuator that passively produces an actuator output based on a temperature or a pressure of the turbine engine, a lubricant injector providing the lubricant to the gear assembly, and a lubricant control module receiving the actuator output. The lubricant injector includes a plurality of orifices including a first orifice type providing a first output and a second orifice type providing a second output greater than the first output. The plurality of orifices receives lubricant from a same feed line, the lubricant exits through the plurality of orifices as a flow of lubricant, and the plurality of orifices directs the lubricant to the gear assembly. The lubricant control module is configured to slidably cover the first orifice type or the second orifice type, depending on a power condition of the turbine engine, to change the flow of lubricant.

The turbine engine of the preceding clause, wherein the sensor is located inside a gearbox assembly containing the gear assembly.

The turbine engine of any preceding clause, wherein the passive actuator passively varies lubricant injections by slidably moving the lubricant control module based upon pressure at the same feed line or temperature in the gearbox.

The turbine engine of any preceding clause, wherein the plurality of orifices extends in a repeating pattern along the lubricant injector, the repeating pattern repeating at least twice.

The turbine engine of any preceding clause, wherein at least one orifice directs at least some fluid tangentially to a surface of a second gear.

The turbine engine of any preceding clause, wherein the lubricant control module moves to cover all orifices of the second orifice type at one position.

The turbine engine of any preceding clause, wherein the lubricant control module covers more orifices when the turbine engine is in a cruise condition than when the turbine engine is in a high-power operating condition.

The turbine engine of any preceding clause, wherein the lubricant control module slidably moves to fully cover some orifices when the turbine engine is in a low-power operating condition or in a mid-level operating condition.

The turbine engine of any preceding clause, wherein the lubricant control module does not cover any orifices when the turbine engine is in a highest-power operating condition.

The turbine engine of any preceding clause, wherein the actuator is a spring actuator with a spring to slidably move the lubricant control module.

The turbine engine of any preceding clause, wherein the actuator is an active actuator that slidably moves the lubricant control module upon activation of a switch or a button.

An assembly for a turbine engine comprising a lubrication control system and a gear assembly. The assembly includes a lubricant supply including a lubricant supply line to feed lubricant to the gearbox, a passive actuator that passively produces an actuator output based on a temperature or a pressure of the turbine engine, a lubricant injector providing the lubricant to the gear assembly, and a lubricant control module receiving the actuator output. The lubricant injector includes a plurality of orifices including a first orifice type providing a first output and a second orifice type providing a second output greater than the first output. The plurality of orifices receives lubricant from a same feed line, the lubricant exits through the plurality of orifices as a flow of lubricant, and the plurality of orifices directs the lubricant to the gear assembly. The lubricant control module is configured to slidably cover the first orifice type or the second orifice type, depending on a power condition of the turbine engine, to change the flow of lubricant.

The assembly of the preceding clause, wherein the sensor is located inside a gearbox assembly containing the gear assembly.

The assembly of any preceding clause, wherein the passive actuator passively varies lubricant injections by slidably moving the lubricant control module based upon pressure at the same feed line or temperature in the gearbox.

The assembly of any preceding clause, wherein the plurality of orifices extends in a repeating pattern along the lubricant injector, the repeating pattern repeating at least twice.

The assembly of any preceding clause, wherein at least one orifice directs at least some fluid tangentially to a surface of a second gear.

The assembly of any preceding clause, wherein the lubricant control module moves to cover all orifices of the second orifice type at one position.

The assembly of any preceding clause, wherein the lubricant control module covers more orifices when the turbine engine is in a cruise condition than when the turbine engine is in a high-power operating condition.

The assembly of any preceding clause, wherein the lubricant control module slidably moves to fully cover some orifices when the turbine engine is in a low-power operating condition or in a mid-level-power operating condition.

The assembly of any preceding clause, wherein the lubricant control module does not cover any orifices when the turbine engine is in a highest-power operating condition.

The assembly of any preceding clause, wherein the actuator is a spring actuator with a spring to slidably move the lubricant control module.

The assembly of any preceding clause, wherein the actuator is an active actuator that slidably moves the lubricant control module upon activation of a switch or a button.

A method of controlling a flow of lubricant to a gear assembly of a turbine engine. The method comprises providing a lubricant supply including a lubricant supply line to feed lubricant to the gearbox, providing a passive actuator that passively produces an actuator output based on a temperature or a pressure of the turbine engine, providing a lubricant injector providing the lubricant to the gear assembly, and receiving, by a lubricant control module, the actuator output. The lubricant injector includes a plurality of orifices including a first orifice type providing a first output and a second orifice type providing a second output greater than the first output. The plurality of orifices receives lubricant from a same feed line, the lubricant exits through the plurality of orifices as a flow of lubricant, and the plurality of orifices directs the lubricant to the gear assembly. The lubricant control module slidably covers the first orifice type or the second orifice type, depending on a power condition of the turbine engine, to change the flow of lubricant.

The method of the preceding clause, further comprising providing the sensor inside a gearbox assembly containing the gear assembly.

The method of any preceding clause, wherein the passive actuator passively varies lubricant injections by slidably moving the lubricant control module based upon pressure at the same feed line or temperature in the gearbox.

The method of any preceding clause, wherein the plurality of orifices extends in a repeating pattern along the lubricant injector, the repeating pattern repeating at least twice.

The method of any preceding clause, further comprising directing, with at least one orifice, at least some fluid tangentially to a surface of a second gear.

The method of any preceding clause, further comprising moving the lubricant control module to cover all orifices of the second orifice type at one position.

The method of any preceding clause, further comprising covering, with the lubricant control module, more orifices when the turbine engine is in a cruise condition than when the turbine engine is in a high-power operating condition.

The method of any preceding clause, further comprising slidably moving the lubricant control module to fully cover some orifices when the turbine engine is in a low-power operating condition or in a mid-level-power operating condition.

The method of any preceding clause, wherein the lubricant control module does not cover any orifices when the turbine engine is in a highest-power operating condition.

The method of any preceding clause, wherein the actuator is a spring actuator, the method further comprising slidably moving the lubricant control module with a spring of the spring actuator.

The method of any preceding clause, wherein the actuator is an active actuator, the method further comprising activating a switch or a button to slidably move the lubricant control module.

Although the foregoing description is directed to embodiments of the present disclosure, other variations and modifications will be apparent to those skilled in the art and may be made without departing from the disclosure. Moreover, features described in connection with one embodiment of the present disclosure may be used in conjunction with other embodiments, even if not explicitly stated above.

1. A lubrication control system for a gear assembly of a gearbox in a turbine engine, the lubrication control system comprising:
a lubricant supply including a lubricant supply line to feed lubricant to the gearbox;
a lubricant injector providing the lubricant to the gear assembly, the lubricant injector including a plurality of orifices including a first orifice type providing a first output and a second orifice type providing a second output greater than the first output, wherein the plurality of orifices receives lubricant from a same feed line, the lubricant exits through the plurality of orifices as a flow of lubricant, and the plurality of orifices directs the lubricant to the gear assembly; and
a lubricant control module configured to slidably cover the first orifice type or the second orifice type to change the flow of lubricant.

2. The lubrication control system of claim 1, wherein the lubricant control module is movable to cover (a) some orifices of the first orifice type and no orifices of the second orifice type at a first position, (b) some orifices of the second orifice type and no orifices of the first orifice type at a second position, or (c) no orifices of the first orifice type and no orifices of the second orifice type at a third position.

3. The lubrication control system of claim 1, wherein the lubricant control module is configured to cover the first orifice type or the second orifice type depending on a power condition of the turbine engine, the power condition being determined by engine conditions experienced by a passive actuator or engine conditions sensed by one or more sensors in communication with a controller controlling an active actuator.

4. The lubrication control system of claim 3, wherein the lubricant control module slidably moves to cover all orifices of the first orifice type during a part-power condition.

5. The lubrication control system of claim 3, further comprising the active actuator, wherein the active actuator slidably moves the lubricant control module based on the power condition of the turbine engine, the power condition being sensed by sensors of a controller, the controller operable to actuate the actuator.

6. The lubrication control system of claim 3, further comprising the passive actuator, wherein the power condition of the turbine engine directly or indirectly affects a pressure near the passive actuator, the pressure actuating the passive actuator when the pressure is above a predefined pressure threshold.

7. The lubrication control system of claim 3, wherein the lubricant control module is slidably movable in a first direction and a second direction, the lubricant control module including at least one control-module covering bar and at least one control-module opening.

8. The lubrication control system of claim 7, wherein the lubricant supply includes a return line sending excess lubricant to a lubricant tank during a part-power condition or a low-power condition.

9. The lubrication control system of claim 3, wherein the plurality of orifices has at least four orifices, and the plurality of orifices is arranged such that one or more orifices of the first orifice type and one or more orifices of the second orifice type extend along the lubricant injector from end to end in a repeating pattern.

10. The lubrication control system of claim 9, wherein the lubricant control module covers at least some orifices of the plurality of orifices when the power condition decreases.

11. A method of controlling lubricant flow to a gear assembly of a gearbox in a turbine engine, the method comprising:
providing a lubricant supply including a lubricant supply line to feed lubricant to the gearbox;
providing the lubricant to the gear assembly via a lubricant injector, the lubricant injector including a plurality of orifices including a first orifice type providing a first output and a second orifice type providing a second output greater than the first output, wherein the plurality of orifices receives lubricant from a same feed line, the lubricant exits through the plurality of orifices as a flow of lubricant, and the plurality of orifices directs the lubricant to the gear assembly; and
slidably moving a lubricant control module, via an actuator, to cover the first orifice type or the second orifice type to change the flow of lubricant.

12. The method of claim 11, further comprising slidably moving the lubricant control module to cover (a) some orifices of the first orifice type and no orifices of the second orifice type at a first position, (b) some orifices of the second orifice type and no orifices of the first orifice type at a second position, or (c) no orifices of the first orifice type and no orifices of the second orifice type at a third position.

13. The method of claim 11, further comprising slidably moving the lubricant control module in a first direction and a second direction, the lubricant control module including at least one control-module covering bar and at least one control-module opening.

14. The method of claim 11, further comprising slidably moving the lubricant control module to cover the first orifice type or the second orifice type depending on a power condition of the turbine engine, the power condition being determined by engine conditions experienced by a passive actuator or engine conditions sensed by one or more sensors in communication with a controller controlling an active actuator.

15. The method of claim 14, further comprising slidably moving the lubricant control module to cover all orifices of the first orifice type during a part-power condition.

16. The method of claim 14, wherein the turbine engine further comprises an HP shaft and an LP shaft, the method further comprising slidably moving the lubricant control module with the active actuator based on an input from a controller, wherein the input from the controller is based upon speed of the turbine engine, torque of the HP shaft, or torque of the LP shaft.

17. The method of claim 14, further comprising slidably moving the lubricant control module with the active actuator based on an input from a controller, wherein the input from the controller is based upon pressure at the lubricant supply line or temperature in the gearbox.

18. The method of claim 14, further comprising slidably moving, via a passive actuator, the lubricant control module over some orifices of the plurality of orifices after pressure at the lubricant supply line drops below a predefined pressure threshold or a temperature at an outlet of the gearbox drops below a predefined temperature threshold.

19. The method of claim 14, further comprising arranging the plurality of orifices such that one or more orifices of the first orifice type and one or more orifices of the second orifice type extend along the lubricant injector from end to end in a repeating pattern.

20. The method of claim 19, further comprising covering, with the lubricant control module, at least some orifices of the plurality of orifices when the power condition decreases.
